(19) United States
(12) Patent Application Publication
(10) Pub. No.: US 2005/0052998 A1
(43) Pub. Date: Mar. 10, 2005

(54) Management of peer-to-peer networks using reputation data

(76) Inventors: Huw Edward Oliver, Bristol (GB); Johannes Maria Victor Daanen, Bristol (GB)

Correspondence Address: HEWLETT-PACKARD COMPANY;Intellectual Property Administration, P.O. Box 272400, Fort Collins, CO, 80527-2400, US

(21) Appl. No.: 10/815,409

(22) Filed: Apr. 1, 2004

(30) Foreign Application Priority Data
Apr. 5, 2003 (GB) 0307913.4

(51) Int. Cl. H04L 1/00

(52) U.S. Cl. 370/231

(57) ABSTRACT

A method of operating a computer entity in a peer-to-peer network is provided in which the computer entity carries out a reputation management process in which it collects reputation data items and uses them to monitor and manage at least one other said computer entity of said network. A computer entity for implementing this method is also disclosed.

### FIELD OF THE INVENTION

The present invention relates to the management of peer-to-peer networks using reputation data.

### BACKGROUND TO THE INVENTION

Network management systems for fault diagnosis and utilisation monitoring of networks of telecommunications equipment, and for monitoring of computer networks are known in the art. Examples include the known Hewlett-Packard Open View network management system.

Prior art computer networks are usually managed through a centralised system which observes and collects data about the state of the network. The management system is usually operated by a human user who reacts according to a network management policy in order to configure the network, detect and repair faults, undertake accounting functions, optimise performance of the network, and enforce security within the network.

Prior art network management systems require centralisation of management at a particular computer node in the network, and human supervision, and are effectively hierarchical in nature.

Prior art computer networks which operate on a peer to peer basis using a peer to peer protocol, for example the known Gnutella protocol, are known in which each computer treats each other computer in the network as its own equivalent. Instead of a master—slave relationship, involving hierarchical control structures, each computer entity within a peer to peer network can act either as a server to provide resources or services to another computer in the network, or as a client, accessing resources or services of another computer entity within the network. Within such peer to peer networks, network management is not well developed in the prior art, since peer to peer networks are not adapted to a centralised management system and individual human network managers who apply overall control of network management policies, and network configurations.

It is a basic assumption in a peer to peer network that each computer entity will be able to supply resources to the network, as well as utilise resources of the network. However, in practice it is found that some computer entities routinely use services provided by other computers within the network, but do not supply resources to the network. These computers are known as ‘freeloaders’ or ‘freeriders’. An example of a freeloader in a Napster network would be a computer which routinely downloaded music files, but never provides any music files to other computers on the network.

In the prior art peer to peer computer networks, since all computers are treated as equivalent by the prior art peer to peer protocols, there is no overall one person or computer which is in a position to manage the network, and there is no mechanism for dealing with problems such as freeloaders, faulty computers, or other problems which may occur with individual peer members of the network.

Consequently, in peer to peer networks, computers which exhibit ‘freeloading’ or ‘freeriding’ exist, and also computers which give poor quality of service or poor quality of resources can also exist within peer to peer networks, without there being any reliable mechanism for excluding those computer entities.

Further, computer members of a peer to peer network can undergo rapid degradation or enhancement of their capabilities or performance over a short period of time. For example, where a new website is introduced which out performs a previous website, the performance of a computer can improve significantly. On the other hand, where a quality of service of a computer resulting from a fault or a performance problem occurs, the service and resources provided by that computer may quickly fall below a minimum acceptable standard.

The task of monitoring computers within a peer to peer network, to detect changes in performance of individual computers, faults, and changes in quality of service provide by individual computers or service providers is not well addressed in the prior art.

### SUMMARY OF THE INVENTION

According to a first aspect of the present invention, there is provided a method of operating a computer entity in a network of computer entities that communicate with each other on a peer-to-peer basis, the method comprising operating a reputation management process for managing at least one other said computer entity of the network; the management process comprising:
(a) collecting a plurality of reputation data items, each reputation data item describing an aspect of operation of a said at least one other computer entity of said network;
(b) monitoring said plurality of reputation data items; and
(c) generating an alert message in response to changes in at least one said reputation data item.

According to a second aspect of the present invention, there is provided a computer entity comprising:
a computer platform capable of providing a set of resources including communication resources for communicating with other computer entities on a peer-to-peer basis; and
a reputation service component capable of providing a reputation service for monitoring quality of service parameters of at least one said other computer entity; said reputation service component being arranged to:
   collect a plurality of reputation data items each describing an aspect of operation of a said at least one other computer entity; and
   generate an alert message in response to changes in at least one said reputation data item.

According to a third aspect of the present invention, there is provided a data storage medium storing program data for operating a computer entity in a network of computer entities, said program data comprising instructions for causing said computer entity to:
operate a peer-to-peer protocol for communicating with other computer entities of said network; and
perform a management process for management of at least one other said computer entity of said network, said management process comprising:
   collecting a plurality of reputation data items, each reputation data item describing an aspect of operation of a said at least one other computer entity of said network;
   monitoring said plurality of reputation data items; and
   generating an alert message in response to changes in at least one said reputation data item.

According to a fourth aspect of the present invention, there is provided a method of operating a plurality of computer entities in a computer network, said plurality of computer entities interacting on a peer to peer basis, the method comprising:
each said computer entity operating a peer to peer protocol allowing the computer entity to interact with at least one other said computer entity of said network;
at least one said computer entity of said network performing a management process comprising collecting reputation data from at least one other said computer entity of said network, said reputation data describing at least one user's perception of a performance parameter of one or more said computer entities of said network.

According to a fifth aspect of the present invention, there is provided a method of operating a computer entity, said method comprising the processes of:
collecting reputation data from a plurality of computer entities in a peer to peer network, the reputation data collected from each entity of said plurality describing a user's perception of a performance parameter of one or more other computer entities of said network;
analyzing said reputation data to identify changes in reputation data for individual ones of said other computer entities;
upon determining a significant change in reputation data, generating a reputation message, said reputation message describing a reputation of said at least one other computer entity; and
sending said reputation message to at least one other computer entity of said network.

According to a sixth aspect of the present invention, there is provided a computer entity adapted for communication on a peer-to-peer basis with other computer entities and comprising:
a data collection arrangement for collecting reputation data from a plurality of computer entities in a peer to peer network, the reputation data collected from each entity of said plurality describing a user's perception of a performance parameter of one or more other computer entities of said network;
an analysis arrangement for analyzing said reputation data to identify changes in reputation data for individual ones of said other computer entities;
a message generation arrangement arranged to respond to the identification arrangement identifying a significant change in reputation data, by generating a reputation message describing a reputation of said at least one other computer entity; and
an output arrangement for sending said reputation message to at least one other computer entity of said network.

According to a seventh aspect of the present invention, there is provided a method of operating a computer entity in a network of computer entities that communicate with each other on a peer-to-peer basis, said method comprising:
collecting reputation data about at least one other computer entity in said network;
monitoring said reputation data to detect changes in performance of said at least one other computer entity;
broadcasting a message describing said reputation data, or changes in reputation data, to other peer computer entities in said network; and
applying a voting protocol to determine a group action of a plurality of peer computer entities in respect of said at least one other computer entity about which said reputation data has been collected.

According to an eighth aspect of the present invention, there is provided a computer entity adapted for communication on a peer-to-peer basis with other computer entities and comprising:
a data collection arrangement for collecting reputation data about at least one other said computer entity;
a monitoring arrangement for monitoring said reputation data to detect changes in performance of said at least one other computer entity;
an output arrangement for sending a message describing said reputation data, or changes in reputation data, to peer computer entities; and
a voting arrangement for causing a voting protocol to be applied to determine a group action of a plurality of peer computer entities in respect of said at least one other computer entity about which said reputation data has been collected.

Other aspects of the invention are as recited in the claims herein. The scope of the invention is limited only by the features of the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a network of peer to peer connected computer entities in an arbitrarily connected peer to peer network, having a network management system according to a specific implementation of the present invention;

FIG. 2 illustrates schematically components of each peer computer of the network of FIG. 1, showing a set of resources provided by each computer, and a network management application resident at each peer computer;

FIG. 3 illustrates schematically logical components of a peer computer entity, showing a network management application, and a component for monitoring reputation of individual computers of the networks;

FIG. 4 illustrates schematically process steps carried out by a computer for collecting and monitoring reputation data according to a specific method of the present invention;

FIG. 5 illustrates schematically a database component for storing reputation data;

FIG. 6 illustrates schematically monitoring and analysis components comprising a peer computer entity;

FIG. 7 illustrates schematically a process carried out by a peer computer entity for determining whether or not to use another peer computer entity in a network, the determination being based upon reputation data; and

FIG. 8 illustrates schematically a reputation data message for transferring reputation data between peer computers within a peer to peer network.

### DETAILED DESCRIPTION OF THE SPECIFIC MODE FOR CARRYING OUT THE INVENTION

There will now be described by way of example the specific mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

Specific implementations according to the present invention aim to utilise the reputation which attaches to a member of a peer to peer network to make decisions about how to deal with that member. Reputation data is generated in a distributed manner without central management.

In specific implementations, reputation data collected in the peer to peer computer network is input into a distributed peer to peer network management system. The reputation data which represents a perceived quality of use information, is used within the network management system to supplement prior art management information types which is gathered by the system, for making decisions about the member of the peer community.

According to a specific method of the present invention, reputation data collected by nodes of the network is used to provide management services to the network. For example, if the reputation data being collected by the network shows an abrupt change of level of service or reputation of a particular node, then that information can be used to manage the network.

Reputation is a general estimate about the past behaviour of a member computer of a peer to peer community. It can be used to make decisions about which member computer to deal with in future. Reputation data is generated in a distributed manner without central management. Specific implementations according to the present invention collect reputation data in a peer to peer environment, and use that reputation as an input to a distributed peer to peer management system. The perceived quality of use information contained within the reputation data is used within the management system to augment the traditional prior art type management information gathered by the system.

Typically quality of use information would include information about an abrupt change in an estimate of a member computers quality of service, reputation, or of a consistently low reputation. Such information may indicate a fault or performance problem which may be used to trigger the management system to carry out a further diagnosis of that member computer, and possibly take re-configuration action, or other system management actions, for example isolating the member computer from the rest of the network.

A detailed description of a specific mode of implementation now follows.

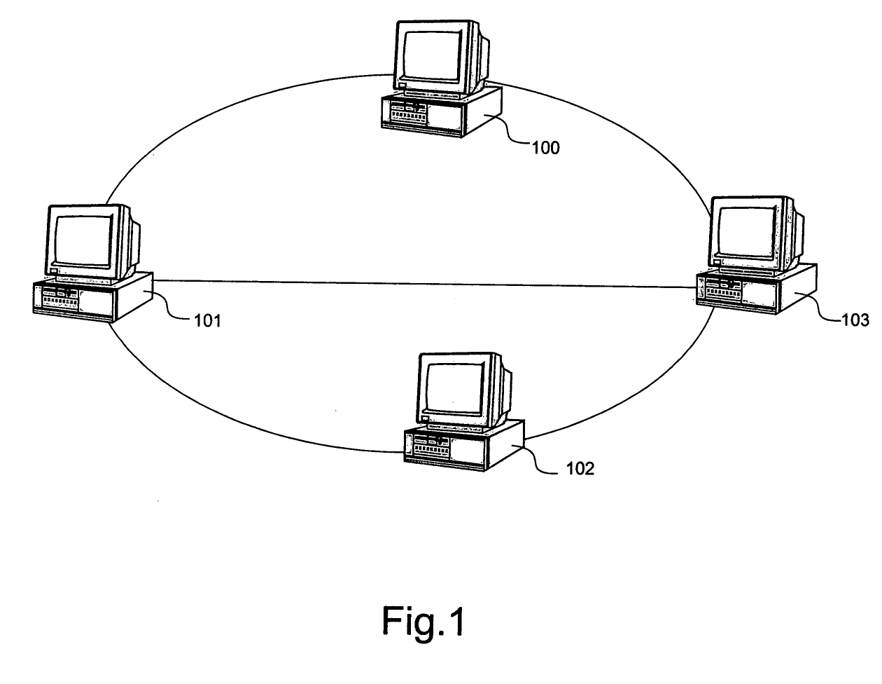

Referring to FIG. 1 herein, there is illustrated schematically a network of peer to peer connected computer entities. Within the network, each computer entity 100-103 is treated as being equivalent to each other computer entity, according to a peer to peer networking protocol.

In the general case, individual nodes may connect to each other in an arbitrary connectivity, so any node can connect to any one or more other nodes in the network. Examples of prior art peer to peer networking protocols include the Gnutella protocol and the Napster protocol.

Individual nodes communicate and interact with each other for provision and exchanges of services, and utilisation of resources. Human users at each node have opinions on the ease of use, quality of service, and other parameters which indicate whether they are satisfied with a service or resource provided at another node which they are using. This information is input into the user's computer entity, by means of key stokes on a keypad, or by clicking an icon presented on screen, indicating whether the user is satisfied, not satisfied, or indicating in some other way a level of user satisfaction with another node in the network which that user may be communicating with via their computer entity. This ‘reputation data’, is collected by many nodes in the network. Computer entities can exchange reputation data with each other, by means of reputation data messages transmitted between individual computers in the network, so that reputation data permeates throughout the network, and each computer entity can be accorded a set of reputation data, being a collection of value judgements made by human users of that computer entity based at other nodes in the network.

Within a network of peer to peer connected computer entities, each 10 individual computer entity has knowledge of at least one other individual computer entity within the network. However, an individual computer entity does not necessarily store data identifying all computer entities within the network. Typically, each computer entity in the network will store address data identifying a plurality of other computer entities within the network, which forms a ‘group’ of which that computer entity is aware. Individual computer entities in the network may each have their own ‘group’ of which they are a member, and the totality of all the groups in the network comprises the network as a whole. The connectivity within the network can range from one extreme case where every computer entity in the network is aware of every other computer entity in the network, to another extreme, in which every computer entity in the network is aware of a small number of other computer entities in the network, for example one or two. Consequently, because a network in general comprises a plurality of groups of computer entities, it cannot be assumed that any one computer entity has a knowledge of the level of services and resources available at any other computer entity, and whether or not that other computer entity is a good choice of computer entity to interact with. Transfer of reputation data between computer entities, as a reputation service, provides a means of transferring information about the reputation of individual computer entities and propagating that information throughout the network to other computers within the network.

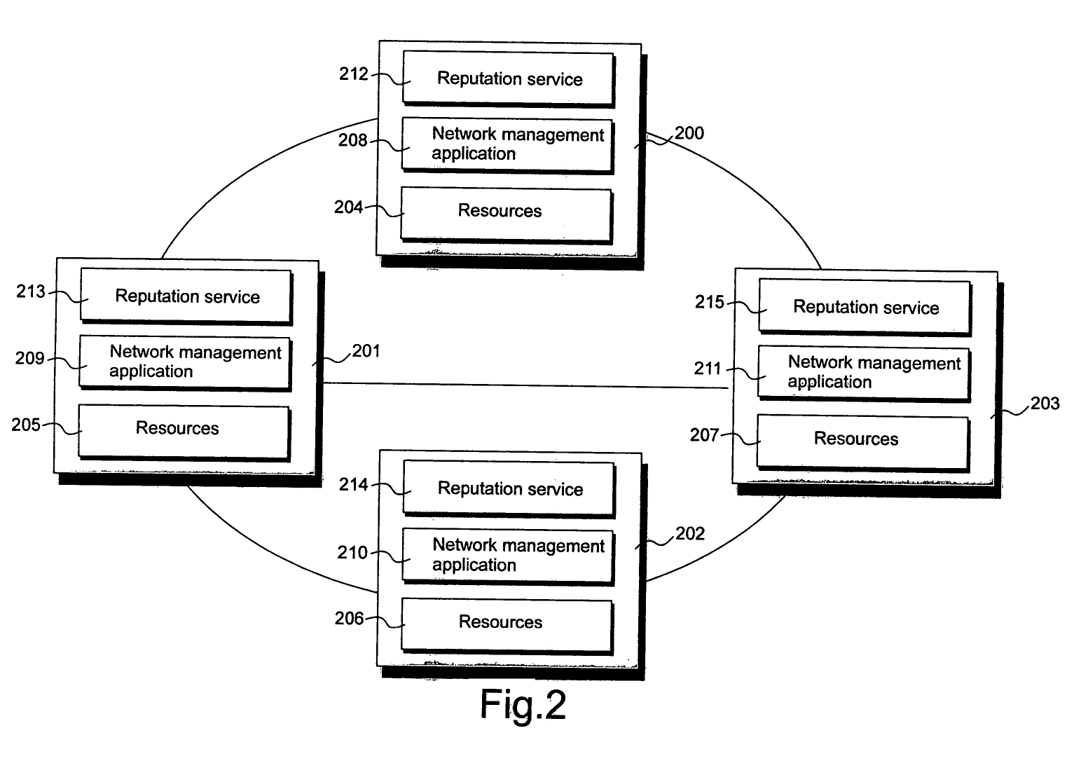

Referring to FIG. 2 herein, the peer to peer network shown in FIG. 1 can be represented as a series of nodes 200-203, each node representing a computer entity, the nodes connecting by a plurality of links. Each node comprises a computer entity having resources 204-207 comprising, for example data storage capacity, bit rate capacity (bandwidth), connectivity, applications services, for example for providing an e-commerce service; and data processing capability. Each node also comprises a network management component 208-211, for providing network management functionality, in the form of one or more network management applications and a reputation services component 212-215, comprising a reputation service application program.

Because there is no centralised management system within a peer to peer network, management of the network needs to be carried out at individual peer computers.

In a network, the resources resident on each computer constitute a resource layer, which is available for peer computer entities within the network. The plurality of reputation service components constitute a reputation service layer which operates across the network, and the plurality of management components resident on the computer entities constitutes a management layer which is effective across the network.

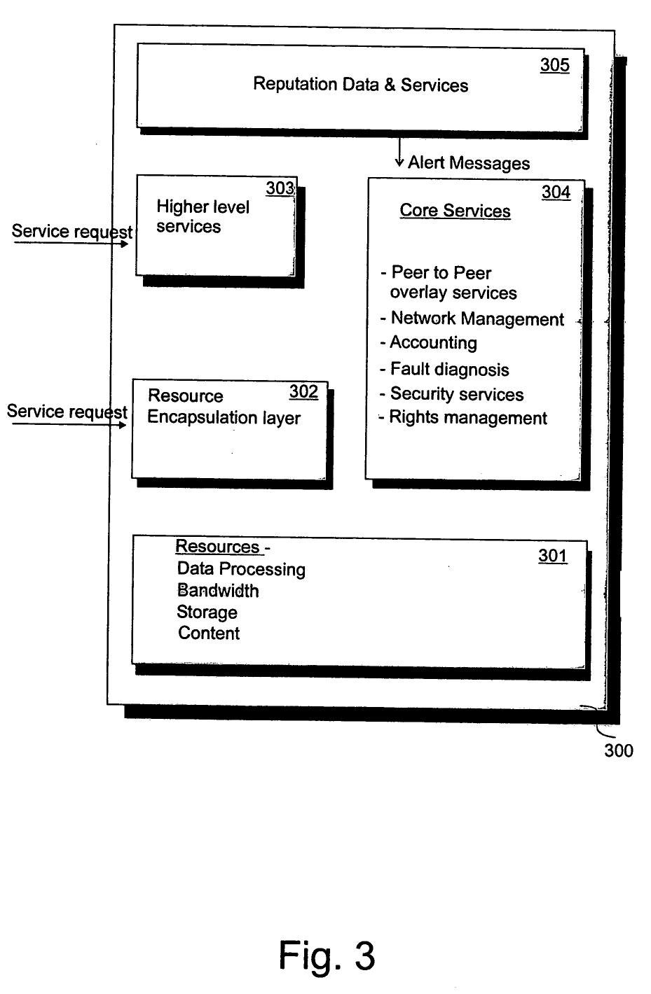

Referring to FIG. 3 herein, there is illustrated schematically logical components of a peer computer entity 300 of the network. The peer computer entity comprises a set of resources 301, including data storage capacity, data processing capacity, file content, including text files, image files, or the like, and bit rate capacity (bandwidth); a resource encapsulation layer 302 which receives service requests from other peer computers within a network for requesting usage of the resource; a set of higher level services 303 which can be provided to other peer computer entities in response to one or more service requests from those peer computers; a set of core services 304 including a peer to peer overlay protocol, a digital rights management protocol, accounting services and fault management service and a security service; and a reputation data and services component 305 for providing reputation data and services to the network.

The resources 301 are available for use by a user of the computer, via a known user interface, including a keyboard, mouse type device, and visual display device, and can also be used by other computer entities in the network, which access the peer computer using the peer to peer overlay service, the resources being accessed in response to a plurality of service requests. Some of the resources are transferable to other computers, for example data files, image files, or application programs which can be transferred in the form of electronic data signals over a communications link. Other resources of the computer are not transferable to other peer computers, but must be provided on-line, for example bandwidth, data storage capacity, and data processing capacity.

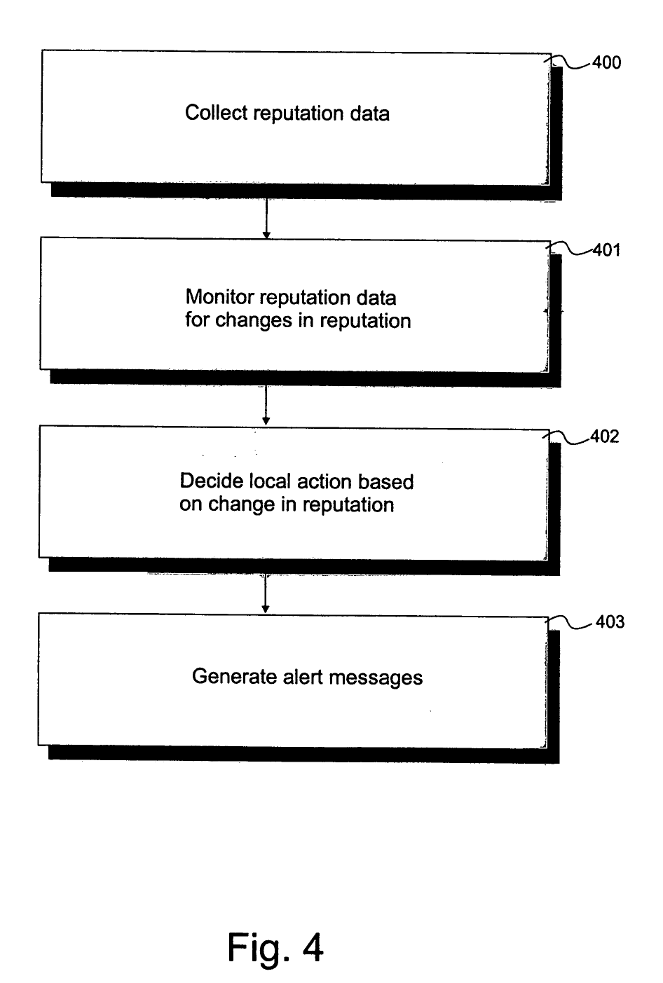

Referring to FIG. 4 herein, there is illustrated in broad overview, process steps carried out by a peer computer entity for collecting and monitoring reputation data according to a specific method of the present invention. The process steps are carried out by the reputation services component by way of program instructions to a computer platform of the computer entity.

In process 400, the computer entity collects reputation data from a plurality of other peer computer entities within the network and from other sources for example, data fed back through users of peer computers within the network. In process 401, the reputation data is continuously monitored by the computer, and any abrupt changes in reputation, or changes in reputation beyond pre-determined limits are identified. In process 402, a management action is determined, on the basis of the reputation data received. In process 403, alert messages are generated and sent to the network management component, alerting the network management component that a possible fault is present in a node.

Network management comprises functionality such as:
fault management—isolation of faults at individual computer entities, identification of faults, and, rectification of faults;
security management—managing authorisation of access to resources by particular computer entities, exclusion of computer entities from a network which are not authorised, or which are insecure;
account management—creation and maintenance of user accounts upon the computer entities.

Some of the specific methods presented herein make the assumption that an abrupt change in the reputation of a computer node providing an on line service is not due to an abrupt change in the business or commercial reputation of a person operating the computer entity, but is more likely due to a technical fault or problem on a particular computer entity within the network.

The reputation monitoring component 305 continuously monitors the reputation of each of a plurality of nodes in the network as a background running operation, and when it detects a significant change in reputation of a node, generates an alert message which is sent to the network management component.

By reputation data, it is meant data which describes a user's perception of their experience with a service provided by a particular computer entity. For example, reputation data may comprise feedback information collected from a plurality of web browsers indicating whether particular users of those web browsers have had a good or bad experience in using a website. Reputation data can take various different forms, and can either by objective, or subjective. An example of an objective feedback reputation data may be whether a website has supplied a particular product of service in accordance with a contract, or did not supply it. This is objective, because most people would agree that failure to deliver on a contract is universally regarded objectively as an indication of poor service. On the other hand, an example of subjective reputation data may comprise information on whether a person did or did not find what they were looking for on a website. If the person does not find what they are looking for on a website, that may be simply because they have gone to the wrong website which provides products or service which is not suitable for their needs. By continuously monitoring reputation data, of both of the objective and subjective types, for a plurality of different nodes, any abrupt changes in reputation data being collected can indicate the possible existence of a technical fault or problem with that particular computer node.

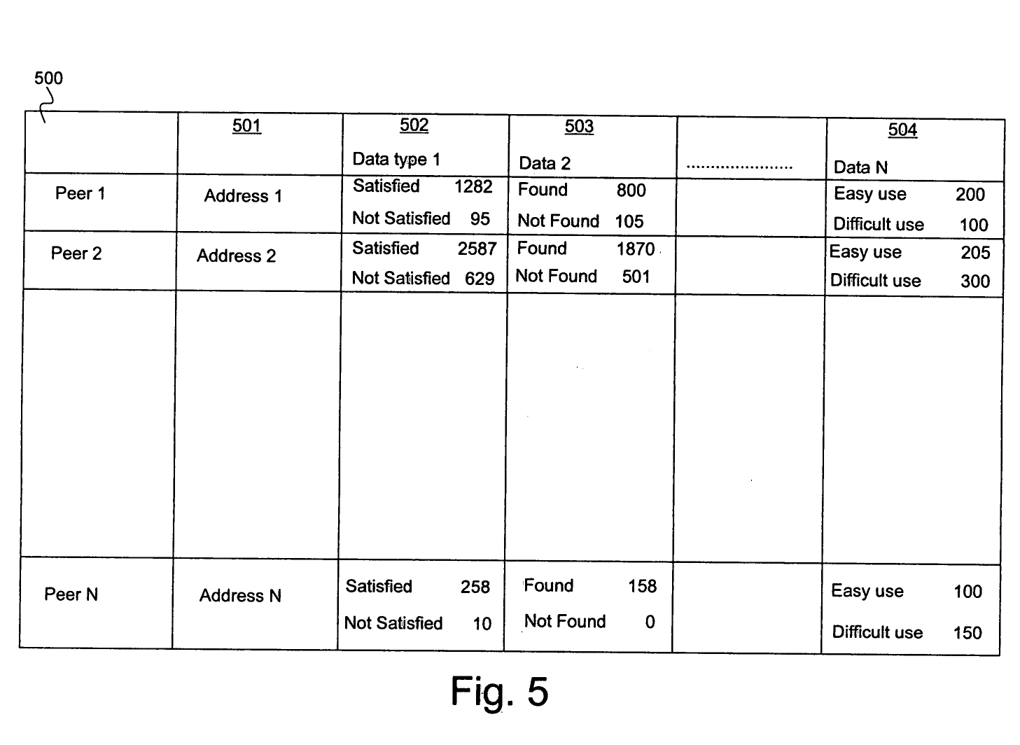

Referring to FIG. 5 herein, there is illustrated schematically, a database component of the reputation component 305. The reputation data and services component collects cumulative reputation data from a plurality of sources, describing a plurality of user's perception of a product or service provided. by a particular node computer in the network.

For each computer entity in the network, the reputation component stores one or more data types describing feedback data for that computer node. Each data type generally comprises two sub-types, being positive or negative. Periodically, the data may be analysed, by a set of analysis applications.

Data fields include a first data field 500 identifying a plurality of individual peer computers in the network by a unique address identifier 501, for example an internet address, or a user account number; a list of reputation data metrics 502-504, where each data type represents a different type of reputation information collected for a particular node.

Examples of reputation data types may include the following:
Satisfied/Not satisfied—data describing whether a user of a particular node is satisfied with their experience of the node or not satisfied
Found what I wanted/Didn't find what I wanted—data describing whether a user of a node found what they wanted at that particular node, or did not find what they wanted at that node
Easy to use/Difficult to use—data describing whether users found a node easy to use or difficult to use.
Fast response/Slow response—data describing whether the response times for deliver of service or resources were fast or slow, according to users of that node.
Service provided/Service not provided—data describing whether users were able to connect effectively to the node and obtain service, or not connect to the node and therefore not obtain service or resources

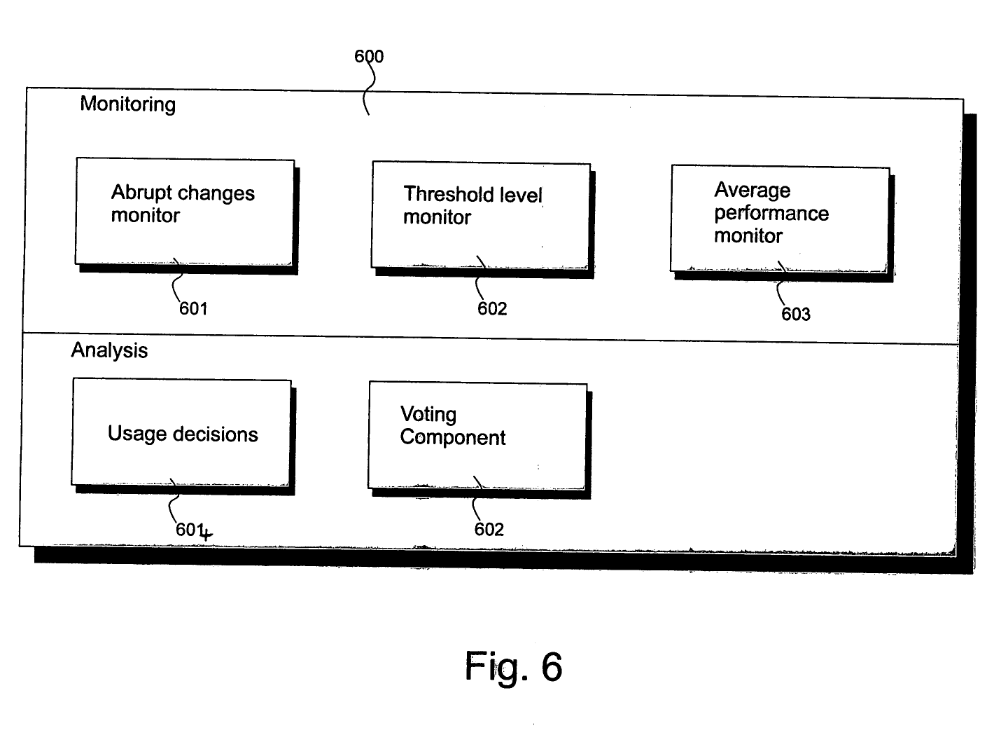

Referring to FIG. 6 herein, there is illustrated schematically individual monitoring and analysis components comprising the reputation services program, for monitoring reputation data collected by a local computer entity from a plurality of other computer entities comprising a peer to peer network. The monitoring components comprise:

An abrupt change monitoring component 601, which monitors for abrupt changes in any reputation data types. Abrupt changes may in particular include abrupt adverse changes in reputation data, which may indicate that a particular computer entity is experiencing a technical fault or other technical problems.

A threshold level monitor 602 monitors reputation data against a pre-determined threshold level. The threshold level can be calculated over a long period of historical reputation data, for example an average value of a reputation data type taken over months or years. When a value of a reputation data reaches the predetermined threshold level, then this may indicate that a fault has occurred with a particular computer entity. The threshold level monitor may be useful in generating alert messages when a reputation data value gradually creeps towards a value which indicates a sub-optimal performance of a computer node, but without encountering any abrupt changes.

An average performance monitoring component 603 monitors an average value of a reputation data type for each computer of a plurality of computer entities. By monitoring a moving average of the reputation data type, fluctuation in usage patterns of the computer entity can be averaged out, to obtain an underlying assessment of the reputation data type being measured.

The abrupt change monitor monitors for abrupt changes in reputation data types over a short time scale, of minutes or hours. The average performance monitor module monitors for changes in reputation data occurring over a medium term time period, for example days or weeks. The threshold level monitor 602 monitors for long term changes in reputation data, which may indicate a gradual change of a reputation data type which is not picked up by either the abrupt changes monitor or the average performance monitor.

Analysis components include:

A usage decision component 604—the usage decision component inspects individual reputation data types for a plurality of computer entities in the network, and selects an optimum computer entity, on the basis of reputation data, with which a local computer entity hosting the usage decision component can interact for obtaining a particular service.

A voting component 605 operates a voting protocol allowing the computer entity to engage with a plurality of other computer entities in the network in order to take a group decision to determine an action to be applied to a specified node within the network.

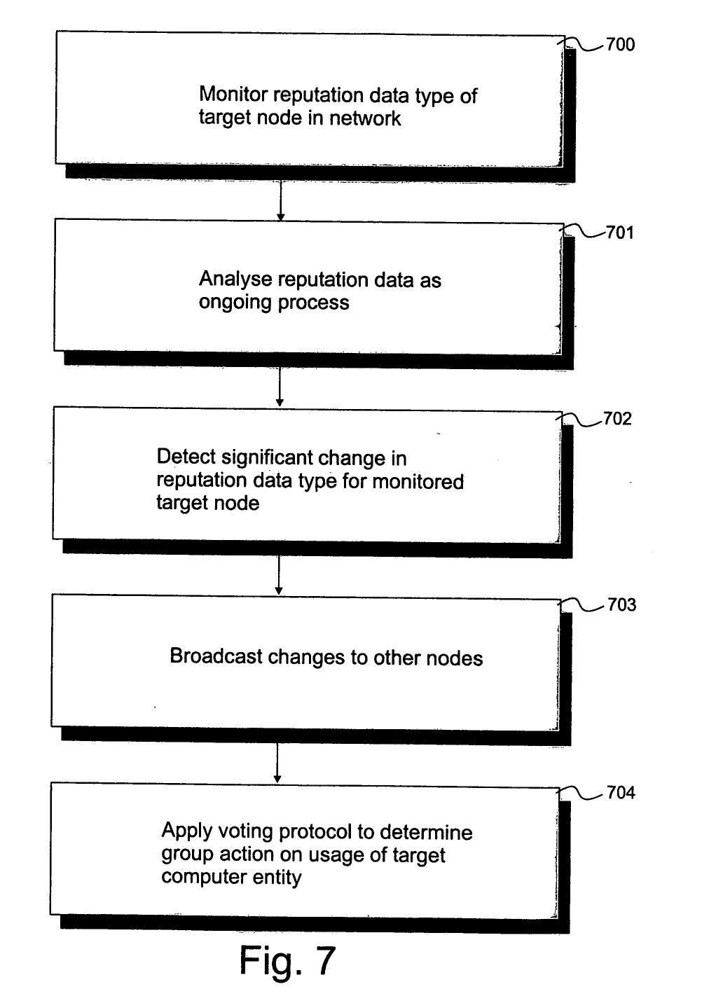

Referring to FIG. 7 herein, there is illustrated schematically in broad overview, process steps carried out by the computer entity for determining whether to use a particular computer entity in the network, referred to herein as a ‘target’ computer entity. The process of FIG. 7 is operated independently by each of a plurality of computer entities within a peer to peer network. In process 700 the local computer entity monitors one or more reputation data types of a target node in the network. The target node may be selected either at random from a list of other peer computer entities in the network stored in the database, or may be inspected as a routine monitoring operation taking each computer entity in sequence from a list of computer entities. In process 701 the local computer entity analyses the reputation data as an ongoing process. Each of the abrupt changes monitor 601, the threshold level monitor 602 or the average performance monitor 603 may continually monitor a reputation data type, and can at any time, detect a change in the reputation data type in process 702 for the monitored target computer, which is significant enough to give rise to an alert message, whenever a reputation data type of that target computer satisfies the criteria for giving rise to an alert message applied by each of the monitoring components. In process 703, having generated an alert message, the local computer entity may broadcast the alert message to one or a plurality of other computer entities at nodes within the, network. In process 704 the local computer entity may apply a voting protocol in order to determine an action to be taken in respect of the target computer entity.

Since each computer entity operates the process of FIG. 7 independently and in parallel, each computer entity independently makes its own assessment of other target computer entities in the network. Exchanges of information between computer entities is by broadcast of alert messages in process 703, and by engaging in a voting protocol in process 704 for deciding a global joint action to be taken in respect of the target computer entity.

Typically, in a large network comprising many nodes, each individual node will not store data about every other computer entity within the network. Individual nodes may gain an appreciation of the reputation of a previously unknown node by receiving reputation messages from one or more other computer entities within the network.

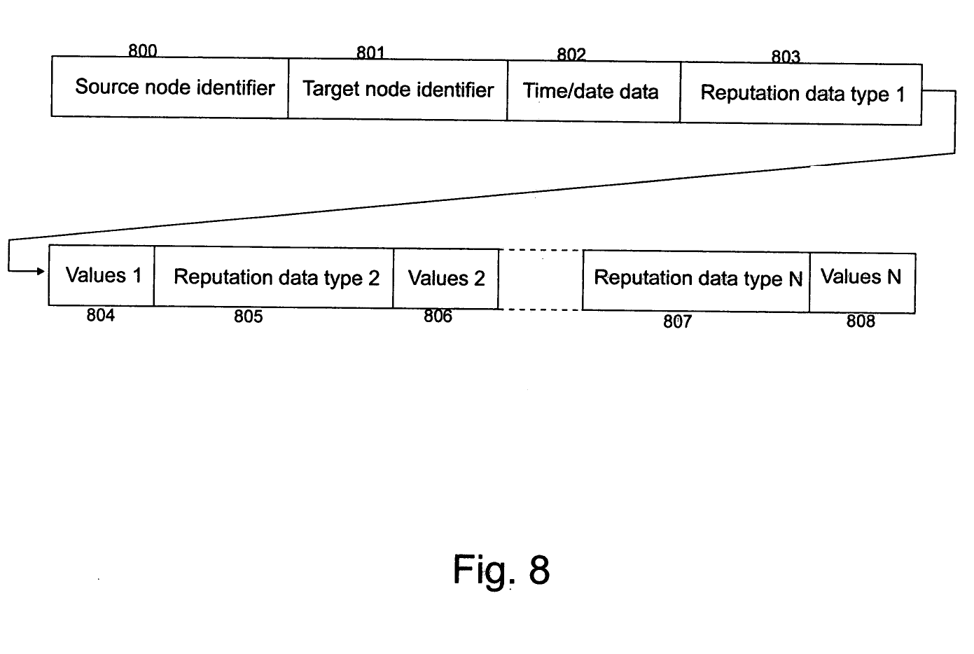

Referring to FIG. 8 herein, there is illustrated schematically a message format for sending a reputation data message between computer entities within the network. The message comprises a source node identifier field 800 for identifying a computer entity generating the message; a target node identifier 801 identifying a computer node in the network which is subject of the message, and to which the reputation data applies; a plurality of reputation data type fields 803, 805, 807 each defining a type of reputation data which attaches to the target identified; and a plurality of reputation data value fields 804, 806, 808 respectively, each value field giving a value for a particular reputation data type which applies to the target node subject of the message.

Reputation data messages may be transferred asynchronously between different computer nodes within the network, so that an individual computer node can build up a picture of a reputation data of other individual computer nodes in the network, without directly collecting reputation for each and every node within the network in order to gain an appreciation of the performance of those other individual nodes.

Once a particular computer entity has determined that a target node in the network has a poor performance parameter, that is it has a poor reputation, then it communicates that information to other peer computers within the network, of which it is aware, so that the reputation data, or changes in reputation data, concerning that selected target node propagates through the network to other peer computers within the network. Typically, the other peer computers within the network may not have a prior knowledge, i.e. a prior stored data, concerning the reputation of the target node, and so effectively, a reputation message sent from the computer entity concerning the target node to the other peer nodes in the network comprises a reputation service provided by the local computer entity to the other peer computers in the network.

After propagation of a reputation message, this may trigger an operation of a voting protocol, so that a group of computers which have received information concerning the reputation of the target node may then engage in a local voting protocol amongst that group of computers, to determine group action to be taken in respect of the target computer entity having the degraded reputation. The result of the voting protocol may be a joint action to isolate that node from the network.

As a result of the voting protocol, a lower layer network management functionality may be activated, for fault management, security management, account management or virus isolation, or any other known network management function. For example, the computer entity may start ‘pinging’ the target computer entity to test that target computer entity to see if there is a fault with the connectivity of the target computer entity.

In the above described embodiment, reputation data is collected at a high level, and monitored to see if there are significant changes in reputation data. A detected significant change in reputation data gives rise to an alert message, which is passed down to a lower level management service, which performs network management functions such as fault management, security management, virus containment and testing of computer entities.

Significant changes in reputation data generated in the reputation service layer are also used to trigger generation of reputation messages which are propagated throughout the network to other computer entities within a peer to peer network.

Some specific implementations presented herein do not rely upon intervention of a human network manager, but may run automatically when a computer entity hosts a peer to peer protocol.

Reputation data collected from a plurality of human users of a peer to peer network is accumulated at individual nodes within the network, and is used to perform an automated reputation service in which individual nodes of the network are monitored, and any significant changes in reputation of a node may propagate by way of reputation data messages throughout the network to other computer entities in the network.

1. A method of operating a computer entity in a network of computer entities that communicate with each other on a peer-to-peer basis, the method comprising operating a reputation management process for managing at least one other said computer entity of the network; the management process comprising:
(a) collecting a plurality of reputation data items, each reputation data item describing an aspect of operation of a said at least one other computer entity of said network;
(b) monitoring said plurality of reputation data items; and
(c) generating an alert message in response to changes in at least one said reputation data item.

2. The method as claimed in claim 1, further comprising, multi-casting said alert message to a plurality of other said computer entities.

3. The method as claimed in claim 1, further comprising applying a voting protocol to determine a group action on usage of said at least one other said computer entity.

4. The method as claimed in claim 1, comprising determining changes in performance of said at least one other computer entity from changes in said reputation data items.

5. The method as claimed in claim 1, comprising sensing abrupt changes of a said aspect of operation of a said at least one other computer entity whereby to determine the possible existence of a technical operating problem with that entity, and outputting an alert message indicating this possible technical operating problem.

6. The method as claimed in claim 1, wherein said reputation data is collected from a plurality of peer computer entities, which are operable to access said at least one other computer entity of which said changes in performance are sensed.

7. The method as claimed in claim 1, wherein the reputation data items have types selected from the set:
a satisfaction data describing whether a user of a computer entity of said network is satisfied with their experience of said at least one other computer entity, or is not satisfied;
a found/not found data describing whether a user of a computer entity of said network found a service at a particular said at least one other computer entity or did not find said services at said particular said at least one other computer entity;
an ease of use data describing whether a user found a specified computer entity to be easy to use or to be difficult to use;
a service provision data describing whether a computer entity is capable of providing a service or resource, to a user requesting said service or resource, or whether said computer entity is incapable of providing said service or resource.

8. The method as claimed in claim 1, wherein step (a) comprises storing reputation data in a database locally at said computer entity, said reputation data describing at least one reputation data type for each of one or a plurality of other computer entities of said network; and step (b) comprises analysing said reputation data to determine a performance parameter of at least one said computer entity.

9. The method as claimed in claim 1, wherein the reputation data items provide reputation data describing a plurality of user experiences of one or a plurality of other computer entities of said network, step (c) comprising generating a set of alert messages dependant upon a reputation data collected in step (a).

10. The method as claimed in claim 1, further comprising determining whether to interact with said at least one other computer entity on the basis of reputation data derived from the reputation data items collected in respect of said at least one other computer entity.

11. A computer entity comprising:
a computer platform capable of providing a set of resources including communication resources for communicating with other computer entities on a peer-to-peer basis; and
a reputation service component capable of providing a reputation service for monitoring quality of service parameters of at least one said other computer entity; said reputation service component being arranged to:
collect a plurality of reputation data items each describing an aspect of operation of a said at least one other computer entity; and
generate an alert message in response to changes in at least one said reputation data item.

12. The computer entity as claimed-in claim 11, wherein said reputation service component is further arranged to multi-cast said alert message to a plurality of peer computer entities.

13. The computer entity as claimed in claim 11, wherein said reputation service component is further arranged to apply a voting protocol to determine a group action on usage of said at least one other said computer entity.

14. The computer entity as claimed in claim 11, wherein said reputation service component is arranged to generate a said alert message in response to detection of changes in said reputation data items indicative of changes in performance of said at least one other computer entity.

15. The computer entity as claimed in claim 11, wherein said reputation service component is arranged to generate a said alert message in response to an abrupt change in reputation of said at least one other said computer entity that is indicative of the possible existence of a technical operating problem with that entity.

16. The computer entity as claimed in claim 11, wherein the reputation service component further comprises at least one analysis component for analyzing a reputation data item.

17. The computer entity as claimed in claim 11, wherein the reputation service component is arranged to collect reputation data items from a plurality of computer entities in a peer to peer network; the reputation service component being further arranged:
to analyze the reputation data items and, as a result of this analysis, to identify changes in reputation for individual ones of said other computer entities;
to generate a reputation message upon identifying a significant change in reputation, said reputation message describing a reputation of said at least one other computer entity; and
to send said reputation message to at least one other computer entity of said network.

18. A data storage medium storing program data for operating a computer entity in a network of computer entities, said program data comprising instructions for causing said computer entity to:
operate a peer-to-peer protocol for communicating with other computer entities of said network; and
perform a management process for management of at least one other said computer entity of said network, said management process comprising:
collecting a plurality of reputation data items, each reputation data item describing an aspect of operation of a said at least one other computer entity of said network;
monitoring said plurality of reputation data items; and
generating an alert message in response to changes in at least one said reputation data item.

19. The data storage medium as claimed in claim 17, wherein said instructions are arranged to cause the computer entity to determine the possible existence of a technical operating problem with a said at least one other computer entity from abrupt changes in said reputation data items.

20. A method of operating a plurality of computer entities in a computer network, said plurality of computer entities interacting on a peer to peer basis, the method comprising:
each said computer entity operating a peer to peer protocol allowing the computer entity to interact with at least one other said computer entity of said network;
at least one said computer entity of said network performing a management process comprising collecting reputation data from at least one other said computer entity of said network, said reputation data describing at least, one users perception of a performance parameter of one or more said. computer entities of said network.

21. The method as claimed in claim 20, wherein said reputation data comprises a data type selected from the set:
a satisfaction data describing whether a user of a computer entity of said network is satisfied with their experience of that computer entity, or is not satisfied;
a found/not found data describing whether a user of a computer entity of said network found a service at a computer entity of said network or did not find said service at said computer entity;
an ease of use data describing whether a user found a specified computer entity of said network to be easy to use or to be difficult to use;
a service provision data describing whether a computer entity is capable of providing a service or resource, to a user requesting said service or resource, or whether said computer entity is incapable of providing said service or resource.

22. The method as claimed in claim 20, further comprising identifying technical faults of a said computer entity of said network from an analysis of said reputation data.

23. The method as claimed in claim 20, comprising identifying a change in performance of at least one said computer entity from an analysis of said reputation data.

24. The method as claimed in claim 20, comprising identifying a change of reputation in at least one said computer entity of said network by analysing said is reputation data.

25. The method as claimed in claim 20, further comprising using said reputation data to select a said computer entity to interact with.

26. The method as claimed in claim 20, wherein said management process comprises determining whether or not to interact with a said computer entity of said network, based upon said reputation data collected from said at least one other computer entity.

27. A method of operating a computer entity, said method comprising the processes of:
collecting reputation data from a plurality of computer entities in a peer to peer network; the reputation data collected from each entity of said plurality describing a user's perception of a performance parameter of one or more other computer entities of said network;
analyzing said reputation data to identify changes in reputation data for individual ones of said other computer entities;
upon determining a significant change in reputation data, generating a reputation message, said reputation message describing a reputation of said at least one other computer entity; and
sending said reputation message to at least one other computer entity of said network.

28. The method as claimed in claim 27, wherein said reputation data comprises a data type selected from the set:
a satisfaction data describing whether a user of a computer entity of said network is satisfied with their experience of that computer entity, or is not satisfied;
a found/not found data describing whether a user of a computer entity of said network found a service at a computer entity of said network or did not find said service at said computer entity;
an ease of use data describing whether a user found a specified computer entity of said network to be easy to use or to be difficult to use;
a service provision data describing whether a computer entity is capable of; providing a service or resource, to a user requesting said service or resource, or whether said computer entity is incapable of providing said service or resource.

29. A computer entity adapted for communication on a peer-to-peer basis with other computer entities and comprising:
a data collection arrangement for collecting reputation data from a plurality of computer entities in a peer to peer network, the reputation data collected from each entity of said plurality describing a user's perception of a performance parameter of one or more other computer entities of said network;
an analysis arrangement for analyzing said reputation data to identify changes in reputation data for individual ones of said other computer entities;
a message generation arrangement arranged to respond to the identification arrangement identifying a significant change in reputation data, by generating a reputation message describing a reputation of said at least one other computer entity; and
an output arrangement for sending said reputation message to at least one other computer entity of said network.

30. The computer entity as claimed in claim 29, wherein the analysis arrangement is arranged to identify technical faults of a said computer entity of said network.

31. The computer entity as claimed in claim 29, wherein the analysis arrangement is arranged to identify a change in performance of at least one said computer entity.

32. The computer entity as claimed in claim 29, wherein the analysis arrangement is arranged to identify a change of reputation in at least one said computer entity of said network.

33. A method of operating a computer entity in a network of computer entities that communicate with each other on a peer-to-peer basis, said method comprising:
collecting reputation data about at least one other computer entity in said network;
monitoring said reputation data to detect changes in performance of said at least one other computer entity;
broadcasting a message describing said reputation data, or changes in reputation data, to other peer computer entities in said network; and
applying a voting protocol to determine a group action of a plurality of peer computer entities in respect of said at least one other computer entity about which said reputation data has been collected.

34. The method as claimed in claim 33, wherein said reputation data comprises a data type selected from the set:
a satisfaction data describing whether a user of a computer entity of said network is satisfied with their experience of that computer entity, or is not satisfied;
a found/not found data describing whether a user of a computer entity of said network found a service at a computer entity of said network or did not find said service at said computer entity;
an ease of use data describing whether a user found a specified computer entity of said network to be easy to use or to be difficult to use; a service provision data describing whether a computer entity is capable of providing a service or resource, to a user requesting said service or resource, or whether said computer entity is incapable of providing said service or resource.

35. The method as claimed in claim 33, wherein said reputation data about said at least one other computer entity is provided by at least one further computer entity of said network.

36. The method as claimed in claim 33, wherein following said voting protocol indicating that action is required in respect of said at least one other computer entity, network management functionality is activated to carry out operations in respect of said at least one other computer entity.

37. A computer entity adapted for communication on a peer-to-peer basis with other computer entities and comprising:
a data collection arrangement for collecting reputation data about at least one other said computer entity;
a monitoring arrangement for monitoring said reputation data to detect changes in performance of said at least one other computer entity;
an output arrangement for sending a message describing said reputation data, or changes in reputation data, to peer computer entities; and
a voting arrangement for causing a voting protocol to be applied to determine a group action of a plurality of peer computer entities in respect of said at least one other computer entity about which said reputation data has been collected.

38. The computer entity as claimed in claim 37, wherein said data collection arrangement is arranged to collect said reputation data about at least one other said computer entity from at least one further computer entity of said network.

39. The computer entity as claimed in claim 37, further comprising network management functionality arranged to be activated to carry out operations in respect of said at least one other computer entity upon said voting arrangement indicating that action is required in respect of said at least one other computer entity.
